(19) United States
(12) Patent Application Publication
(10) Pub. No.: US 2015/0180031 A1
(43) Pub. Date: Jun. 25, 2015

(54) LITHIUM METAL OXIDE ELECTRODES FOR LITHIUM BATTERIES

(71) Applicant: UCHICAGO ARGONNE, LLC, Chicago, IL (US)

(72) Inventors: Michael M. THACKERAY, Naperville, IL (US); Jason R. CROY, Plainfield, IL (US); Brandon R. LONG, Plainfield, IL (US)

(73) Assignee: UCHICAGO ARGONNE, LLC, Chicago, IL (US)

(21) Appl. No.: 14/554,666

(22) Filed: Nov. 26, 2014

Related U.S. Application Data
(60) Provisional application No. 61/920,276, filed on Dec. 23, 2013.

(51) Int. Cl. H01M 4/505; H01M 10/052; H01M 4/525

(52) U.S. Cl. CPC H01M 4/505; H01M 4/525; H01M 10/052; H01M 2220/30; H01M 2220/20

(57) ABSTRACT

A lithium-rich spinel metal oxide electrode material has the formula: Li_{1+d}Mn_{2-y-d}M_{y}O₄, wherein 0<d≦0.2; 0.2<y≦0.6, and M comprises Ni. The electrode material provides, in many cases, improved capacity retention on cycling and superior capacity when utilized in the positive electrode of a lithium cell relative to conventional electrode materials. Positive electrodes, electrochemical cells, and batteries comprising the electrode material also are described.

### CROSS-REFERENCE TO RELATED APPLICATIONS

This application claims the benefit of U.S. Provisional Application Ser. No. 61/920,276, filed on Dec. 23, 2013, which is incorporated by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to electrode materials for electrochemical cells and batteries. Such cells and batteries are used widely to power numerous devices, for example, portable electronic appliances and medical, transportation, aerospace, and defense systems.

### BACKGROUND

State-of-the-art lithium batteries do not provide sufficient energy to power electric vehicles for an acceptable driving range. This limitation arises because the electrodes, both the anode, typically graphite, and the cathode, typically, layered LiMO₂ (M=Mn, Co, Ni), spinel LiMn₂O₄, and olivine LiFePO₄, do not offer sufficient capacity or a high enough electrochemical potential to meet the energy demands. Approaches that are currently being adopted to enhance the energy of lithium-ion batteries include the exploitation of recently disclosed cathode materials with composite structures such as ‘layered-layered’ xLi₂MnO₃.(1−x)LiMO₂ (Mn=Mn, Ni, Co) materials and ‘layered-spinel’ xLi₂MnO₃.(1−x)LiM₂O₄ (Mn=Mn, Ni, Co) materials, that offer a significantly higher capacity compared to conventional cathode materials, including the high voltage spinel, LiMn_{1.5}Ni_{0.5}O₄, that operates at a significantly higher voltage (4.7 V) than the conventional spinel LiMn₂O₄ (4.1 V). However, these lithium- and manganese-rich high capacity composite cathodes suffer from ‘voltage fade’ on repeated cycling, which reduces the energy output and efficiency of the cell, thereby compromising the management of cell/battery operation. On the other hand, delithiated Li₁₋ₓMn_{1.5}Ni_{0.5}O₄ electrodes tend to be unstable with respect to organic electrolyte solvents at the high operating potential, compromising the cycle life of the cells.

There is an ongoing need for new electrode materials to ameliorate the problems associated with high-voltage spinel electrode materials. The lithium-rich spinel metal oxides, electrodes, electrochemical cells, and batteries described herein address this need.

### SUMMARY OF THE INVENTION

The present invention provides a lithium-rich spinel metal oxide electrode material which is useful in lithium battery applications. The lithium-rich spinel metal oxide electrode material has the formula: Li_{1+d}Mn_{2-y-d}M_{y}O₄; wherein 0<d≦0.2; 0.2<y≦0.6; and M comprises Ni, Co, or a combination thereof. In some embodiments, M further comprises at least one other transition metal in addition to the Ni, Co, or the combination thereof, for example, a first row transition metal other than Ni and Co (e.g., Fe), a second row transition metal (e.g., Zr or Mo), and the like. In addition, or alternatively, M can further comprise one or more metals selected form a first row transition metal, Al and/or Mg, in addition to the Ni and Co. In some embodiments, the relative excess of lithium in the spinel electrode material, represented by “d”, falls within the range of 0<d≦0.1, or 0<d≦0.05. The relative proportion of M in the spinel electrode material, in some embodiments, falls within the range of 0.4<y≦0.6, or 0.45<y≦0.55. In some embodiments, 0<d≦0.1 and 0.4<y≦0.6, particularly when M is Ni, or comprises Ni and Co.

In one preferred embodiment of the lithium-rich spinel material, 2−y−d is greater than or equal to 1.5, M is Ni_{w}M^{a}_{z}, M^{a} comprises at least one metal selected from the group consisting of a first row transition metal, Al, and Mg, w+z=y; and w is less than 0.5. In another preferred embodiment, 2−y−d is less than 1.5, M is Ni_{w}M^{a}_{z}, M^{a} comprises at least one metal selected from the group consisting of a first row transition metal, Al, and Mg; w+z=y; and w is greater than or equal to 0.5. Preferably, in these embodiments, z is 0 or close to 0 (e.g., 0.1 or less); in other words, M is substantially Ni. In another embodiment, the Li, Mn and M ions of the Li_{1+d}Mn_{2-y-d}M_{y}O₄ spinel structure can be partially disordered in the structure, i.e., the Li, Mn and M ions may partially occupy the tetrahedral and/or octahedral sites of the spinel structure.

Desirably, the lithium rich spinel material can be physically combined with, or integrated with, at least one layered lithium metal oxide. For example, the layered lithium metal oxide component can comprise a material of formula LiM^{b}O₂, wherein M^{b} comprises Mn, Co, Ni, or a combination of two or more thereof. If desired, M^{b} can also include at least one other metal selected, e.g., from the group consisting of a transition metal, Al, and Mg, in addition to the Mn, Co and Ni. In other embodiments, the layered lithium metal oxide component can comprise a material of formula Li₂M^{c}O₃, wherein M^{c} comprises Mn, optionally in combination with at least one metal selected from the group consisting of Ti and Zr, and optionally including another transition metal. In some preferred embodiments, the layered lithium metal oxide component comprises an integrated, layered-layered lithium metal oxide of formula: xLi₂M^{d}O₃.(1−x)LiM^{f}O₂; wherein M^{d} comprises Mn, M^{f} comprises at least one metal selected from Mn, Ni and Co, and 0<x<1. In any of the foregoing embodiments comprising a layered component integrated together with the spinel material, the lithium-rich spinel metal oxide can include alternating layers of metal ions comprising lithium ions and non-lithium metal ions, wherein the lithium ions in the alternating layers constitute greater than 0% and up to about 25% of the total ions in the alternating layers on an atom percentage basis, depending on the formula of the lithium-rich spinel material. The term “integrated” as used herein refers to a material with multiple crystal domains of spinel and layered components sharing a common oxygen lattice; while “physically combined” refers to separately prepared particulate materials that are mixed together, optionally with a binder, to form an electrode material with separate particles of the different materials (e.g., spinel and layered materials) in close proximity or contact with each other. Additionally, the lithium ions and non-lithium metal ions in the spinel and layered components can be partially disordered within the crystal lattice structures thereof (i.e., a partial mixing of some of the ions to form a “hybrid” arrangement that is neither pure spinel or pure layered in form, e.g., boundaries between spinel domains and layered domains in the integrated crystal structure of the material).

In another aspect, the present invention provides a positive electrode for a lithium electrochemical cell comprising a lithium-rich electrode material as described herein (including e.g., a spinel material by itself, or integrated together in a layered-spinel, or a layered-layered-spinel material), optionally formulated with another positive electrode material (e.g., physically mixed with a carbon material, with another metal oxide material, typically held together by a binder). The spinel electrode material can be placed in contact with a current collector, such as a metal foil, or can be coated on the current collector. Such electrodes can be utilized as the positive electrode in a lithium electrochemical cell, in combination with a negative electrode (e.g., a carbon material) in contact with a non-aqueous electrolyte comprising a lithium salt (e.g., LiPF₆, LiBF₄, or other such materials dissolved in a non-aqueous solvent such as propylene carbonate, ethylene carbonate, or a combination thereof). A lithium battery of the present invention comprises a plurality of such electrochemical cells connected together in series, parallel, or both.

### BRIEF DESCRIPTION OF THE DRAWINGS

The invention consists of certain novel features and a combination of parts hereinafter fully described, illustrated in the accompanying drawings, it being understood that various changes in the details may be made without departing from the spirit, or sacrificing any of the advantages of the present invention.

FIG. 1 depicts (top) the electrochemical charge/discharge profiles of a Li/Li_{1.05}Mn_{1.525}Ni_{0.425}O₄ cell, when charged and discharged between 5.0 and 3.5 V (left) and 5.0 and 2.0 (right) at 15 mA/g; and (bottom) the electrochemical charge/discharge profiles of a Li/Li_{1.05}Mn_{1.367}Ni_{0.583}O₄ cell, when charged and discharged between 5.0 and 3.5 V (left) and 5.0 and 2.0 (right) at 15 mA/g.

FIG. 2 depicts (top) the dQ/dV plots of a Li/Li_{1.05}Mn_{1.525}Ni_{0.425}O₄ cell, when charged and discharged between 5.0 and 3.5 V, 3.5 and 2.0 V, and 5.0 and 2.0 V at 15 mA/g; and (bottom) the dQ/dV plots of a Li/Li_{1.05}Mn_{1.367}Ni_{0.583}O₄ cell, when charged and discharged between 5.0 and 3.5 V, 3.5 and 2.0 V, and 5.0 and 2.0 V at 15 mA/g.

FIG. 3 depicts the electrochemical charge/discharge profiles of a standard Li/LiMn_{1.5}Ni_{0.5}O₄ cell, when charged and discharged between 5.0 and 3.5 V (left) and 5.0 and 2.0 (right) at 15 mA/g.

FIG. 4 depicts the electrochemical charge/discharge profiles of a Li/cathode cell in which the cathode is a physical blend containing 15 wt % Li_{1.05}Mn_{1.525}Ni_{0.425}O₄ and 85% 0.5Li₂MnO₃.(1−x)LiMn_{0.5}Ni_{0.5}O₂ when charged and discharged between 5.0 and 2.0 V at 15 mA/g.

FIG. 5 provides plots of discharge capacity versus cycle number (Panel A), and voltage versus capacity (Panel B) for three spinel-containing samples.

FIG. 6 provides plots of discharge capacity versus cycle number (Panel A), and voltage versus capacity (Panel B) for three spinel-containing samples.

FIG. 7 provides plots of discharge capacity versus cycle number for three spinel-containing samples.

FIG. 8 depicts a schematic representation of an electrochemical cell.

FIG. 9 depicts a schematic representation of a battery consisting of a plurality of cells connected electrically in series and in parallel.

### DETAILED DESCRIPTION OF PREFERRED EMBODIMENTS

The electrode materials of the present invention address the limitations of high-voltage spinel electrode materials (e.g., LiMn_{1.5}Ni_{0.5}O₄), by a number of means. For example, these limitations can be addressed, first, by stabilizing the electrodes with extra lithium to access additional rechargeable capacity at lower voltage (approximately 3 V); second, by introducing cobalt into the structure to raise the operating voltage of the low-voltage spinel plateau; third, by integrating the spinel with a layered or composite ‘layered-layered’ structure to tune the operating potential of the cell and to enhance the cycling stability over a wide potential range; and fourth, by a combination of two or more of the first, second and third means. As used herein, the term “lithium-rich” as applied to a LiM₂O₄ spinel, means a material having greater than one lithium for every four oxygen atoms in the spinel formula or, alternatively, having a Li:M ratio (in which M is a metal other than lithium) greater than 1:2 (i.e., 0.5), such as 1.05:1.95 (i.e., 0.538).

The composition of the novel lithium-rich spinel materials of the invention is broadly defined as conforming to the stoichiometric spinel formula of Li_{1+d}Mn_{2-y-d}M_{y}O₄, in which (a) M comprises one or more metals, such as Ni, Co, Al, Mg, but always including at least some Ni. In some preferred embodiments, M is Ni and Co; or M is Ni. The excess lithium coefficient “d” falls within the range 0<d≦0.2, preferably 0<d≦0.1, and more preferably 0<d≦0.05. The coefficient “y”, which represents the relative proportion of M in the formula, falls within the range 0.2<y≦0.6, preferably 0.4<y≦0.6, and more preferably 0.45<y≦0.55. Preferably, when M is Ni and the Mn coefficient (2−y−d) is greater or equal to 1.5, the Ni coefficient (y) is less than 0.5; and when the 2-y-d is less than 1.5, y is greater than or equal to 0.5. The total number of Li, Mn and M ions in the stoichiometric Li_{1+d}Mn_{2-y-d}M_{y}O₄ spinel formula is three metal ions per four oxygen ions, recognizing that, when used in an electrochemical cell, the lithium content of the [Mn_{2-y-d}M_{y}]O₄ spinel framework will vary during charge (i.e., lithium extraction from the spinel metal oxide to form a lithium-depleted material), and during discharge (i.e., lithium insertion into the lithium-depleted framework). Typically, during charge and discharge, the oxidation state of the manganese ions may vary between 4+ and 3+, whereas the oxidation state of the M cations may vary from 4+ to 2+. Notwithstanding these changes in oxidation state, other redox processes may also occur during the electrochemical redox processes, for example, those that access higher or lower oxidation states of the Mn and/or M cations, and/or redox processes that occur on the oxygen ions. Preferably, the theoretical capacity of the electrode should be greater than 100 mAh/g, more preferably greater than 150 mAh/g, and most preferably greater than 200 mAh/g. The principles of this invention are formulated by way of example in Table 1, which provides examples of lithium-rich spinel formulae, as well as the theoretical metal oxidation states and theoretical capacities of the materials.

TABLE 1
Theoretical capacities and Mn/Ni/Co oxidation states
for lithium extraction at high voltage (about 4.7 V)

| Stoichiometry of | | | Theoretical | Theoretical | | Theoretical |
|---|---|---|---|---|---|---|
| spinel phases | | | Mn ox. | Ni ox. | Fully oxidized | capacity† |
| Li_{1+d}Mn_{2-d-y}M_{y}O₄ | d | y | state* | state* | composition | (mAh/g) |
| LiMn_{1.5}Ni_{0.5}O₄ | 0 | 0.5 | 4.00 | 2.00 | Mn_{1.500}Ni_{0.500}O₄ | 153 |
| Li_{1.05}Mn_{1.367}Ni_{0.583}O₄ | 0.05 | 0.583 | 4.00 | 2.54 | Li_{0.20}Mn_{1.367}Ni_{0.583}O₄ | 130 |
| Li_{1.05}Mn_{1.525}Ni_{0.425}O₄ | 0.05 | 0.425 | 4.00 | 2.00 | Li_{0.20}Mn_{1.525}Ni_{0.425}O₄ | 131 |
| Li_{1.10}Mn_{1.400}Ni_{0.500}O₄ | 0.1 | 0.5 | 4.00 | 2.60 | Li_{0.40}Mn_{1.400}Ni_{0.500}O₄ | 108 |
| Li_{1.10}Mn_{1.550}Ni_{0.350}O₄ | 0.1 | 0.35 | 4.00 | 2.00 | Li_{0.40}Mn_{1.550}Ni_{0.350}O₄ | 109 |
| Li_{1.05}Mn_{1.367}Ni_{0.500}Co_{0.083}O₄ | 0.05 | 0.583 | 4.00 | 2.54(Ni) | Li_{0.20}Mn_{1.367}Ni_{0.500}Co_{0.083}O₄ | 130 |
| | | | | 2.54(Co) | | |

Theoretical capacities and Mn/Ni/Co oxidation states
over the full voltage range (4.7-2.0 V)

| Stoichiometry of | | | Theoretical | Theoretical | | Theoretical |
|---|---|---|---|---|---|---|
| spinel phases | | | Mn ox. | Ni ox. | Fully reduced | capacity†† |
| Li_{1+d}Mn_{2-d-y}M_{y}O₄ | d | y | state* | state** | composition | (mAh/g) |
| LiMn_{1.5}Ni_{0.5}O₄ | 0 | 0.5 | 3.33 | 2.00 | Li_{2.00}Mn_{1.500}Ni_{0.500}O₄ | 305 |
| Li_{1.05}Mn_{1.367}Ni_{0.583}O₄ | 0.05 | 0.583 | 3.50 | 2.00 | Li_{2.05}Mn_{1.367}Ni_{0.583}O₄ | 284 |
| Li_{1.05}Mn_{1.525}Ni_{0.425}O₄ | 0.05 | 0.425 | 3.34 | 2.00 | Li_{2.05}Mn_{1.525}Ni_{0.425}O₄ | 285 |
| Li_{1.10}Mn_{1.400}Ni_{0.500}O₄ | 0.1 | 0.5 | 3.50 | 2.00 | Li_{2.10}Mn_{1.400}Ni_{0.500}O₄ | 263 |
| Li_{1.10}Mn_{1.550}Ni_{0.350}O₄ | 0.1 | 0.35 | 3.35 | 2.00 | Li_{2.10}Mn_{1.550}Ni_{0.350}O₄ | 264 |
| Li_{1.05}Mn_{1.367}Ni_{0.500}Co_{0.083}O₄ | 0.05 | 0.583 | 3.50 | 2.00(Ni) | Li_{2.05}Mn_{1.367}Ni_{0.500}Co_{0.083}O₄ | 284 |
| | | | | 2.00(Co) | | |

*Oxidation states in the parent (Li_{1+d}Mn_{2-d-y}Ni_{y}O₄) electrode.
**Oxidation states in fully reduced (Li_{2+d}Mn_{2-d-y}Ni_{y}O₄) electrode.
†Theoretical capacity, based on starting at and the mass of the fully-oxidized composition (Li_{d}Mn_{2-d-y}Ni_{y}O₄) when discharged to the stoichiometric spinel composition (Li_{1+d}Mn_{2-d-y}Ni_{y}O₄).
††Theoretical capacity, based on starting at and the mass of the fully-oxidized composition, when discharged to the fully reduced composition (Li_{2+d}Mn_{2-d-y}Ni_{y}O₄).

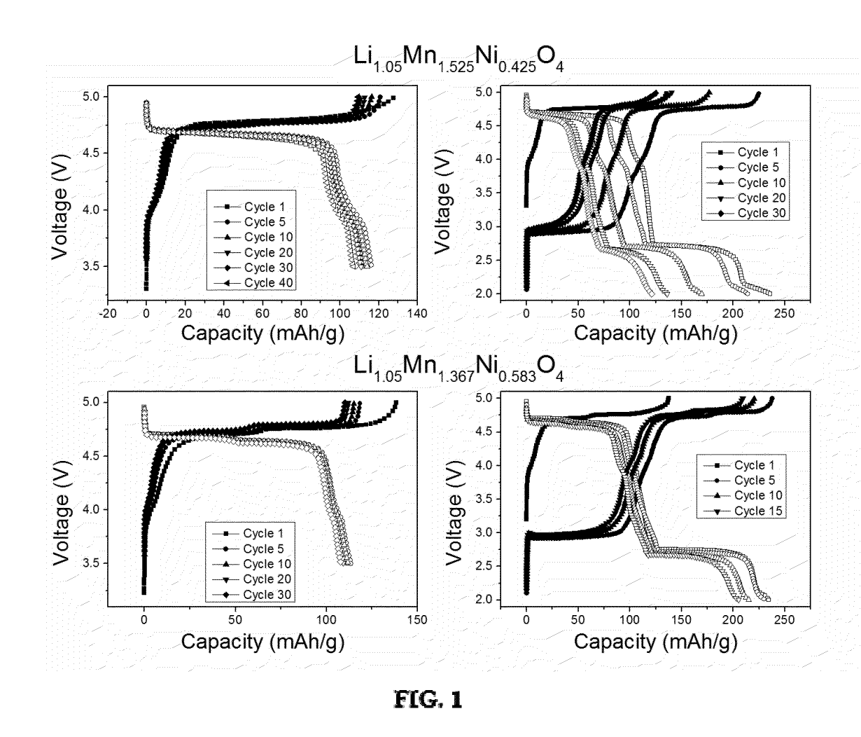

The principles of this invention have been reduced to practice. For example, the data in FIG. 1 show a significant improvement in capacity retention on cycling for an electrode with the composition Li_{1.05}Mn_{1.367}Ni_{0.583}O₄, in which the oxidation state of the manganese ions is at, or above, 3.5+ during the electrochemical charge/discharge processes, relative to an electrode composition Li_{1.05}Mn_{1.525}Ni_{0.425}O₄, both on the upper voltage plateau (approximately 4.7 V) and the lower voltage plateau when the average Mn oxidation state falls below 3.5+ during discharge to 2.0 V (see Table 1). Furthermore, when cycled between 5 and 2 V, stabilized Li_{1.05}Mn_{1.367}Ni_{0.583}O₄ electrodes offer the possibility of providing a reversible capacity of more than 200 mAh/g during discharge which is significantly superior to the capacities generated by conventional layered LiCoO₂, spinel LiMn₂O₄ and olivine LiFePO₄ electrodes.

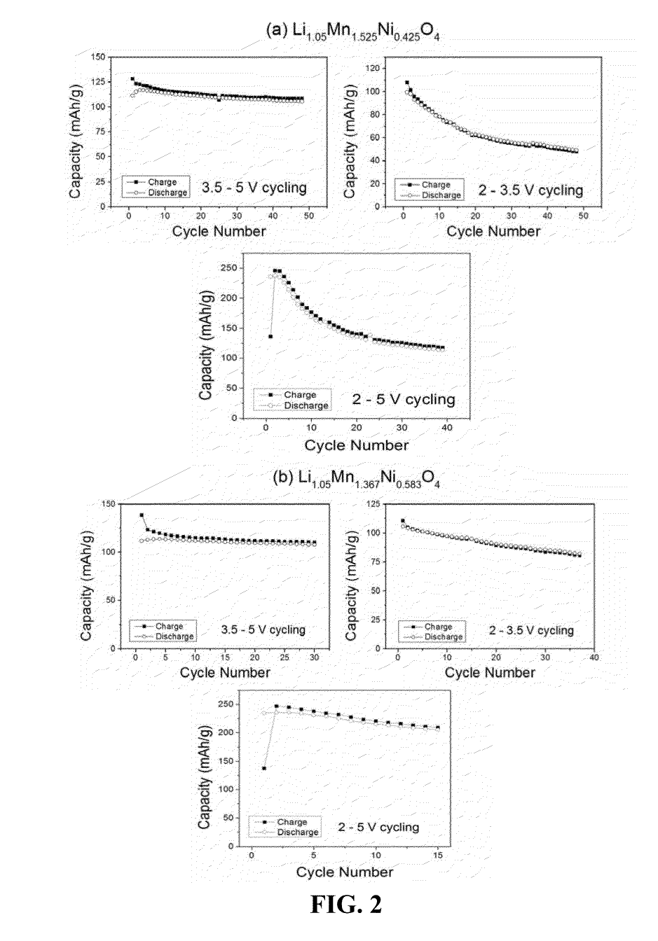

The relative cycling stabilities of Li_{1.05}Mn_{1.525}Ni_{0.425}O₄ and Li_{1.05}Mn_{1.367}Ni_{0.583}O₄ electrodes in lithium half cells are shown in FIGS. 2a and b, respectively. Although fairly good cycling stability was observed for the Li_{1.05}Mn_{1.525}Ni_{0.425}O₄ electrode when cycling was restricted to the upper voltage plateau, the data clearly emphasize the significantly superior cycling stability of Li_{1.05}Mn_{1.367}Ni_{0.583}O₄ over Li_{1.05}Mn_{1.525}Ni_{0.425}O₄ electrodes when cycled over both upper and lower voltage plateaus and the ability to tune and optimize the electrochemical properties and performance of the electrodes of this invention. The relatively poor cycling stability of the Li_{1.05}Mn_{1.525}Ni_{0.425}O₄ electrode over the lower voltage plateau is attributed to the low manganese oxidation state (3.34+) in the electrode on complete discharge (Table 1), i.e., below 3.5+ which typically signifies the onset of a damaging crystallographic Jahn-Teller distortion in lithium-manganese-oxide spinel structures. By contrast, the average manganese oxidation state in the Li_{1.05}Mn_{1.367}Ni_{0.583}O₄ electrode at full discharge only reaches 3.5+(Table 1). The preferred electrodes of this invention are therefore those in which the manganese oxidation state is as close as possible to 3.5+, or above, in the fully discharged state, while enhancing both capacity and cycling stability of state-of-the-art electrodes comprising a spinel component.

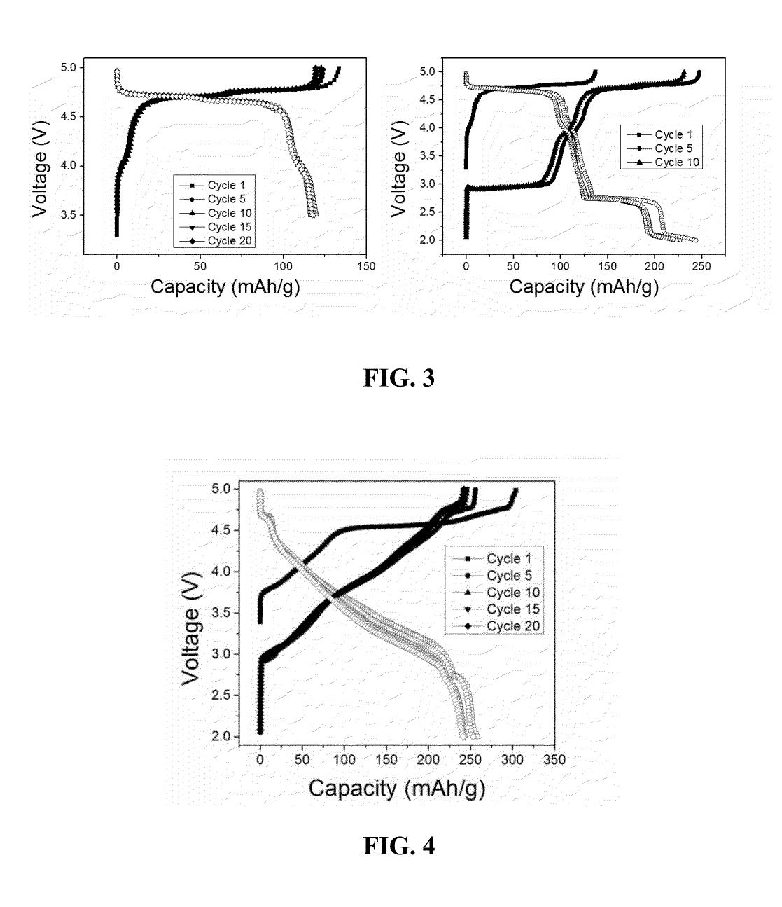

For comparison, the cycling profiles of a standard LiMn_{1.5}Ni_{0.5}O₄ spinel electrode, synthesized and tested by the same procedures and conditions as the Li_{1+δ}Mn_{2-y-δ}M_{y}O₄ electrodes of this invention, are shown in FIG. 3.

It is clear that there are several advantages of the Li_{1+δ}Mn_{2-y-δ}M_{y}O₄ electrodes of the invention such as Li_{1.05}Mn_{1.367}Ni_{0.583}O₄, described and highlighted in FIG. 1 above, relative to LiMn_{1.5}Ni_{0.5}O₄ (FIG. 3). When cycled between 3.5 and 5 V (left figures), the Li_{1.05}Mn_{1.367}Ni_{0.583}O₄ electrode of the invention provides essentially all of its capacity at about 4.6 V and relatively little capacity at about 4 V, unlike the standard LiMn_{1.5}Ni_{0.5}O₄ spinel electrode that delivers significantly more capacity at about 4 V and 2 V, the Li_{1.05}Mn_{1.367}Ni_{0.583}O₄ electrode provides significantly more capacity on the second major plateau at about 2.8 V and, correspondingly, significantly less capacity on the lowest voltage plateau at about 2 V.

In a further embodiment, the spinel electrodes of this invention can be integrated into, or blended with, structurally-compatible electrode materials, particularly those with layered-type structures, whether single phase LiMO₂ materials, in which M is typically a metal ion, such as LiCoO₂ (LCO), LiNi_{0.8}Co_{0.15}AlO₂ (NCA), or more complex composite electrode structures containing an Li₂MnO₃ component as known in the art. These materials have the advantage of providing a voltage profile with both the sloping character of the layered components and the voltage plateaus of the spinel components, thus smoothing the overall voltage profile of high capacity, structurally-integrated, ‘composite’ layered-spinel electrodes of this invention. For example, a physically blended electrode containing 15 wt % Li_{1.05}Mn_{1.525}Ni_{0.425}O₄ and 85% 0.5Li₂MnO₃.(1−x)LiMn_{0.5}Ni_{0.5}O₂ shows remarkable stability when cycled between 5.0 and 2.0 V at 15 mA/g. The electrochemical contribution of the spinel component is clearly visible in FIG. 4 by the short voltage plateaus at about 4.6 and 2.8 V, the cathode providing an overall average capacity of about 250 mAh/g, most of which is delivered smoothly between 4.6 and 2.8 V, for 21 cycles.

The spinel electrode materials of this invention, whether used on their own, physically combined with another metal oxide, or integrated with structurally compatible metal oxides or lithium metal oxides, notably with layered LiMO₂ structures, are broad in compositional scope and structure. For example, in an ideal LiM₂O₄ spinel structure the M cations are distributed in octahedral sites in alternating close-packed oxygen layers in a 3:1 ratio, whereas in an ideal layered structure the M cations occupy all the octahedral sites in alternating layers. Therefore, in the composite layered-spinel structures of this invention, the ratio of M cations in alternating layers of the close-packed oxygen array can vary within the structure from the 3:1 ratio of M (Mn+M) to Li in the transition metal layers of an ideal spinel configuration to the corresponding ratio of the ideal layered configuration (i.e., with no Li in the transition metal layers). Furthermore, the M and Li cations of the spinel and layered electrode materials of this invention can be partially disordered, yielding complex cation arrangements in the spinel and layered components that are not ideally configured in the composite structures.

The compositions and structures of the materials of this invention can be synthesized by various processing methods that are known in the art, for example, by sol-gel or precipitation processing techniques using precursors that decompose during synthesis, such as metal hydroxides, carbonates and oxalates, solid state reactions, or by using a Li₂MnO₃ template or precursor as described by Croy et al., in Electrochemistry Communications, Volume 13, pages 1063-1066 (2011). In addition, integration or blending of the spinel electrodes with structurally-compatible electrode materials can be performed by several methods including: physical blending; high-energy physical mixing (i.e. ball mill grinding); separate low-temperature (typically 450° C.-650° C.) firing of the metal oxide and other materials followed by physical mixture, and a subsequent annealing step at higher temperature (typically 750-950° C.).

The materials shown in Table 1 were prepared as follows: (NiMnCo)C₂O₄ (i.e., metal oxalate) precursors were prepared from NiSO₄.6H₂O, MnSO₄.H₂O, CoSO₄.7H₂O, and Na₂C₂O₄ using the required ratios of Ni, Mn and Co for a targeted stoichiometry in the final product. An aqueous solution containing the required stoichiometric amounts of metal sulfates was added under stirring into a solution of the sodium oxalate. The solution was then stirred for about 3 hours at about 70° C. The co-precipitated powder was filtered, washed, and dried in air at about 105° C. The dried powders were thoroughly mixed with stoichiometric amounts of lithium carbonate and annealed at about 450° C. for about 12 hours in air, followed by grinding and an annealing step at about 750° C. for about 12 hours (also in air) to prepare materials with a desired composition. Other annealing conditions included no low temperature intermediate firing step, different annealing times and different annealing temperatures.

Cathodes for the electrochemical tests were prepared by coating Al foil with a slurry containing 82 percent by weight (wt %) of the oxide powder, 8 wt % SUPER P carbon (TIMCAL Ltd.), and 10 wt % polyvinylidene difluoride (PVDF) binder in NMP and assembled in coin cells (size 2032). The cells contained a metallic lithium anode. The electrolyte was a 1.2 M solution of LiPF₆ in a 3:7 mixture of ethylene carbonate (EC) and ethyl methyl carbonate (EMC). Coin cells were assembled in a glovebox under an inert argon atmosphere.

The invention extends to include lithium metal oxide electrode materials (e.g., lithium-rich spinels, layered oxides, and the like) with surface modification, for example, with metal-oxide, metal-fluoride or metal-phosphate layers or coatings to protect the electrode materials from highly oxidizing potentials in the cells and from other undesirable effects, such as electrolyte oxidation, oxygen loss, and/or dissolution. Such surface protection enhances the surface stability, rate capability and cycling stability of the electrode materials.

In some embodiments, individual particles of a powdered lithium metal oxide composition, a surface of the formed electrode, or both, are coated or treated, e.g., in situ during synthesis, for example, with a metal-oxide, a metal-fluoride, a metal-polyanionic material, or a combination thereof, e.g., at least one material selected from the group consisting of (a) lithium fluoride, (b) aluminum fluoride, (c) a lithium-metal-oxide in which the metal is selected preferably, but not exclusively, from the group consisting of Al and Zr, (d) a lithium-metal-phosphate in which the metal is selected from the group consisting preferably, but not exclusively, of Fe, Mn, Co, and Ni, and (e) a lithium-metal-silicate in which the metal is selected from the group consisting preferably, but not exclusively, of Al and Zr. In a preferred embodiment of the invention, the constituents of the treatment or coating, such as the aluminum and fluoride ions of an AlF₃ coating, the lithium and phosphate ions of a lithium phosphate coating, or the lithium, nickel and phosphate ions of a lithium-nickel-phosphate coating can be incorporated in a solution that is contacted with the hydrogen-lithium-manganese-oxide material or the lithium-manganese-oxide precursor when forming the electrodes of this invention. Alternatively, the surface may be treated with fluoride ions, for example, using NH₄F, in which case, the fluoride ions may substitute for oxygen at the surface or at least partially within the bulk of the electrode structure.

Preferably, a formed positive electrode comprises at least about 50 percent by weight (wt %) of a powdered lithium metal oxide composition comprising the lithium-rich spinel material, and an electrochemically inert polymeric binder (e.g., polyvinylidene difluoride; PVDF). Optionally, the positive electrode can comprise up to about 40 wt % carbon (e.g., carbon back, graphite, carbon nanotubes, carbon microspheres, carbon nanospheres, or any other form of particulate carbon).

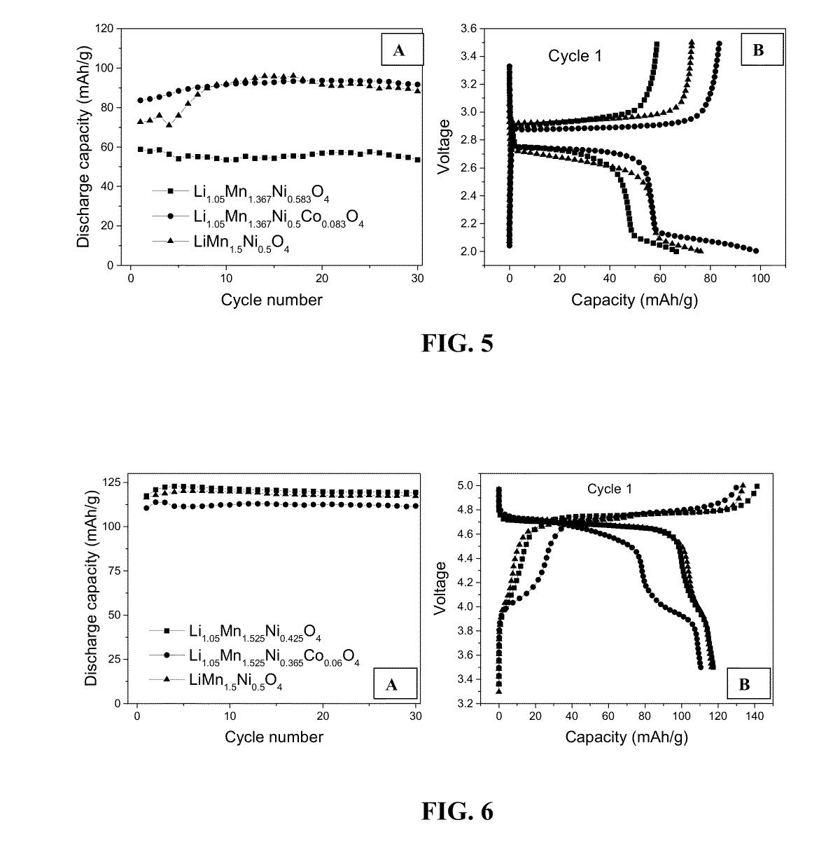

FIG. 5, Panel A, shows the cycling performance of three spinel samples in Li half cells between 2-3.5 V at 15 mA/g: i.e., (a) Li_{1.05}Mn_{1.367}Ni_{0.583}O₄, (b) Li_{1.05}Mn_{1.367}Ni_{0.5}Co_{0.083}O₄, and (c) LiMn_{1.5}Ni_{0.5}O₄. The Li_{1.05}Mn_{1.367}Ni_{0.583}O₄ sample was compositionally designed to operate at the low voltage plateau by maintaining the average oxidation state of Mn above +3.5. The addition of Co provided a Li_{1.05}Mn_{1.367}Ni_{0.5}Co_{0.083}O₄ composition which increased the discharge capacity without a reduction in stability for 30 cycles. A LiMn_{1.5}Ni_{0.5}O₄ spinel is shown for comparison and gives similar performance to the Co containing composition. FIG. 5, Panel B, shows the first cycle voltage profiles for the samples shown in FIG. 5, Panel A.

FIG. 6, Panel A, shows the cycling performance of spinel samples in Li half cells between 3.5-5 V at 15 mA/g: i.e., (a) Li_{1.05}Mn_{1.525}Ni_{0.425}O₄, (b) Li_{1.05}Mn_{1.525}Ni_{0.365}Co_{0.06}O₄, and (c) LiMn_{1.5}Ni_{0.5}O₄. The Li_{1.05}Mn_{1.525}Ni_{0.425}O₄ composition was optimized for the upper voltage plateau by having a Ni oxidation state of +2 in the fully oxidized composition as shown in Table 1. LiMn_{1.5}Ni_{0.5}O₄ exhibited similar performance to the Li_{1.05}Mn_{1.525}Ni_{0.425}O₄ Li-excess spinel. The addition of Co slightly reduced the discharge capacity, while exhibiting more ˜3.9 V activity as seen in the voltage profiles (FIG. 6, Panel B).

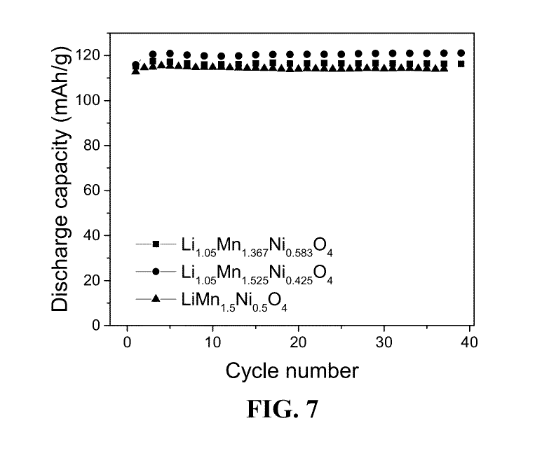

FIG. 7 shows the cycle life performance of spinel materials in a Li half-cell using a fluorinated electrolyte optimized for high voltages when cycled between 3.5-5 V at 15 mA/g. The use of a fluorinated electrolyte limits oxidative decomposition for comparison of structural stability. The Li_{1.05}Mn_{1.525}Ni_{0.425}O₄ spinel, compositionally designed for the upper voltage plateau, showed superior capacity and stability.

### Exemplary Electrochemical Cell and Battery.

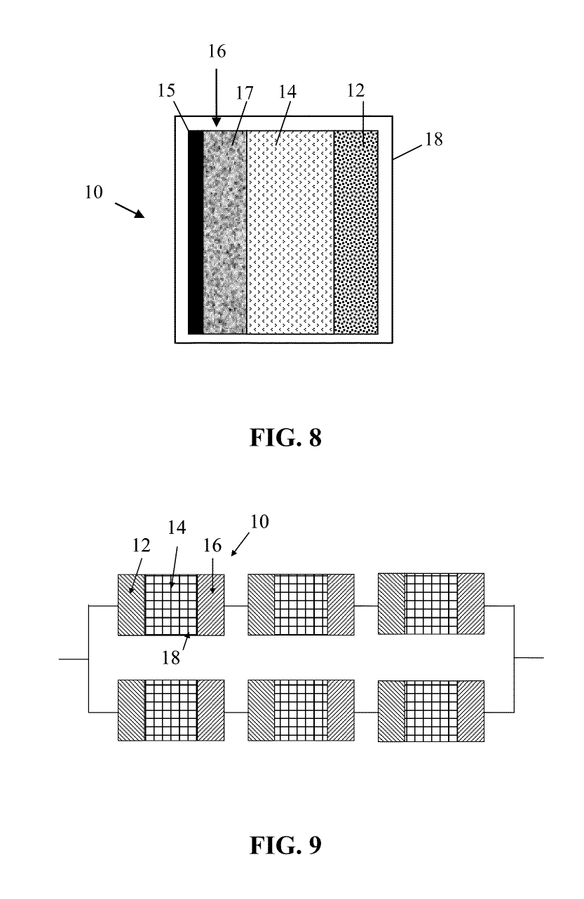

A detailed schematic illustration of a lithium electrochemical cell 10 of the invention is shown in FIG. 8. Cell 10 comprises negative electrode 12 separated from positive electrode 16 by a separator 14 (e.g., a permeable membrane or sheet) saturated with the electrolyte, all contained in insulating housing 18 with suitable terminals (not shown) being provided in electronic contact with negative electrode 12 and positive electrode 16 of the invention. Positive electrode 16 comprises metallic collector plate 15 and active layer 17 comprising the active lithium metal oxide material described herein. FIG. 9 provides a schematic illustration of one example of a battery in which two strings of electrochemical lithium cells 10, described above, are arranged in parallel, each string comprising three cells 10 arranged in series.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. A lithium-rich spinel metal oxide electrode material of formula: Li_{1+d}Mn_{2-y-d}M_{y}O₄; wherein 0<d≦0.2; 0.2<y≦0.6; and M comprises Ni, Co, or a combination thereof.

2. The electrode material of claim 1, wherein M further comprises at least one other transition metal in addition to the Ni, Co, or the combination thereof.

3. The electrode material of claim 1, wherein M further comprises at least one other metal in addition to the Ni, Co, or the combination thereof, wherein the at least one other metal is selected from the group consisting of a first row transition metal, Al, and Mg.

4. The electrode material of claim 1, wherein M is Ni.

5. The electrode material of claim 1, wherein M comprises Ni and Co.

6. The electrode material of claim 1, wherein 0<d≦0.1.

7. The electrode material of claim 1, wherein 0<d≦0.05.

8. The electrode material of claim 1, wherein 0.4<y≦0.6.

9. The electrode of material claim 1, wherein 0.45<y≦0.55.

10. The electrode of material claim 1, wherein 0<d≦0.1, and 0.4<y≦0.6.

11. The electrode material of claim 10, wherein M is Ni.

12. The electrode material of claim 1, wherein M is a combination of Ni and Co.

13. The electrode material of claim 1, wherein 2-y-d is greater than or equal to 1.5; M is Ni_{w}M^{a}_{z}; M^{a} comprises at least one metal selected from the group consisting of a first row transition metal, Al, and Mg; w+z=y; and w is less than 0.5.

14. The electrode material of claim 1, wherein 2-y-d is less than 1.5; M is Ni_{w}M^{a}_{z}; M^{a} comprises at least one metal selected from the group consisting of a first row transition metal, Al, and Mg; w+z=y; and w is greater than or equal to 0.5.

15. The electrode material of claim 1, wherein the lithium-rich spinel metal oxide is combined or integrated with at least one layered lithium metal oxide.

16. The electrode material of claim 15, wherein the lithium-rich spinel metal oxide includes alternating layers of metal ions comprising lithium ions and non-lithium metal ions, wherein the lithium ions in the alternating layers constitute greater than 0% and up to about 25% of the total ions in the layers on an atom percentage basis.

17. The electrode material of claim 15, wherein lithium ions and non-lithium metal ions in the spinel and layered lithium metal oxide are partially disordered within the crystal lattice structures thereof.

18. The electrode material of claim 15, wherein the layered lithium metal oxide comprises a material of formula LiM^{b}O₂; wherein M^{b} comprises Mn, Co, Ni, or a combination of two or more thereof.

19. The electrode material of claim 18, wherein M^{b} further comprises at least one other metal selected from the group consisting of a transition metal, Al, and Mg, in addition to the Mn, Co, Ni, or the combination of two or more thereof.

20. The electrode material of claim 15, wherein the layered lithium metal oxide comprises a material of formula Li₂M^{c}O₃, wherein M^{c} comprises Mn.

21. The electrode material of claim 20, wherein M^{c} further comprises at least one metal selected from the group consisting of Ti and Zr.

22. The electrode material of claim 15, wherein the layered lithium metal oxide comprises an integrated, layered-layered lithium metal oxide of formula xLi₂M^{d}O₃.(1−x)LiM^{f}O₂; wherein M^{d} comprises Mn; M^{f} comprises at least one metal selected from Mn, Ni and Co; and 0<x<1.

23. The electrode material of claim 22, wherein the lithium-rich spinel metal oxide includes alternating layers of metal ions comprising lithium ions and non-lithium metal ions; and the lithium ions in the alternating layers constitute greater than 0% and up to about 25% of the total ions in the layers on an atom percentage basis.

24. The electrode material of claim 23, wherein lithium ions and non-lithium metal ions in the spinel and layered components are partially disordered within the crystal lattice structures thereof.

25. The electrode material of claim 1, wherein the Li, Mn and M ions are partially disordered on tetrahedral and/or octahedral sites of the spinel structure

26. A positive electrode for a lithium electrochemical cell comprising the electrode material of claim 1.

27. A lithium electrochemical cell comprising the positive electrode of claim 26 and a negative electrode in contact with a non-aqueous electrolyte comprising a lithium salt.

28. A lithium battery comprising a plurality of the electrochemical cells of claim 27 connected together in series, parallel, or both.
